(19) United States
(12) Patent Application Publication
(10) Pub. No.: US 2007/0041093 A1
(43) Pub. Date: Feb. 22, 2007

(54) Projector screen for use in a lighted room

(76) Inventor: Stuart Bard, Irving, TX (US)

Correspondence Address: Stuart Bard, P.O. Box 630571, Irving, TX, 75063-0571, US

(21) Appl. No.: 11/209,018

(22) Filed: Aug. 22, 2005

(51) Int. Cl. G03B 21/00

(52) U.S. Cl. 359/443

(57) ABSTRACT

A screen that blocks out ambient light and allows light from a projector to pass through it to sensors. The sensors report the color of the light striking them to a computer. The computer powers lamps so that the same color striking the sensors shines back out to the audience. The lamps mimic the picture coming from the projector.

### CROSS-REFERENCE TO RELATED APPLICATIONS

1. Not Applicable.

### STATEMENT REGARDING FEDERALLY SPONSORED RESEARCH OR DEVELOPMENT

1. Not Applicable.

### REFERENCE TO SEQUENCE LISTING, A TABLE, OR A COMPUTER PROGRAM LISTING COMPACT DISC APPENDIX

1. Not Applicable.

### BACKGROUND OF THE INVENTION

1. To use a projector in a room which is not ordinarily kept dark, there are five problems:
A. Effort must be made to darken the room.
B. When the room is dark, its occupants have difficulty taking notes about what is being said or displayed on the projector screen.
C. Ingress and egress to/from the dark room (not to mention movement within the room) is perilous.
D. Ingress and egress to/from the dark room frequently entails letting more light into the room, making the display on the projector screen harder to see.
E. The reflective quality of current screens is very dim and out of focus, making the display on the projector screen harder to see.

### BRIEF SUMMARY OF THE INVENTION

1. The invention makes the screen for overhead projectors easier to see and allows it to be seen clearly in ambient light, without darkening the room. The invention's screen includes a grating with an array of tiny tube-shaped holes perpendicular to the screen. A projector shines its light roughly parallel to these tubes. Nearly all ambient light from other angles is absorbed by the walls or open end of the tubes. The projector light is the predominant light that passes all the way through the tubes. At the end of each tube is an electronic light sensor which registers the color of the light passing through the tube and passes that color to a computer. The computer causes some light-emitting devices near the sensors to glow, shining the same color striking the sensors back out to the room. The light-emitting devices mimic the picture emitted by the projector. The screen is made up of many of these small tubes, sensors, and light-emitting devices, and is envisioned to be the size of standard projector screens used in meeting rooms. The shining of the light-emitting devices is much brighter than current reflective projector screens and could be as bright as a television.

### BRIEF DESCRIPTION OF THE SEVERAL VIEWS OF THE DRAWING

1. Not Applicable.

### DETAILED DESCRIPTION OF THE INVENTION

1. The invention's screen includes a grating with an array of tiny tube-shaped holes perpendicular to the screen. A projector shines its light roughly parallel to these tubes. Nearly all ambient light from other angles is absorbed by the walls or open end of the tubes. The projector light is the predominant light that passes all the way through the tubes. At the end of each tube is an electronic light sensor which registers the color of the light rays passing through the tube (from the projector), which passes its information to a computer. The computer analyzes the color information from each sensor. For each sensor, the computer then causes some light-emitting devices to glow, in an effort to mimic the color sent by the sensors. When the glow is proximal to the sensors, it mimics reflection of the projector light from a reflective screen. These light-emitting devices may be positioned near the tubes so as to shine the color entering the tubes back out to the room. The light-emitting devices mimic the picture emitted by the projector. The screen is made up of many of these small tubes, sensors, and light-emitting devices.

What is claimed is:

1. A screen arranged to receive light projected by a light projection device, comprising:
A. a grating of an opaque or translucent substance which absorbs or deflects light; and
B. an assembly of electronic light sensors within or behind the grating, which receive light passing through the grating, with or without a transparent or translucent membrane positioned before the electronic light sensors; and
C. an assembly of electronic light-emitting devices which mimic the color of the light striking the electronic light sensors; positioned before, within, behind, or independent of the grating; with or without a transparent or translucent membrane positioned before the electronic light-emitting device.

2. The following computer code for interpretation of the color of light striking electronic light sensors:
Private Sub cmdFinal_Click( )
Dim x As Integer, y As Integer
Dim intUpperBoundX As Integer
Dim intUpperBoundY As Integer
Dim Pixels( ) As Long
Dim str1 As String
Dim intRed As Integer, intGreen As Integer, intBlue As Integer
Dim sngRed As Single, sngGreen As Single, sngBlue As Single
Dim IngMaxWid As Long, IngMaxHeight As Long
Dim IngCurrentPixelX As Long, IngCurrentPixelY As Long
IngMaxWid = HowManyPixels(Picture1.Picture.Width)
IngMaxHeight = HowManyPixels(Picture1.Picture.Height)
Dim thisColor As Long
For x = 1 To 10 ′ IngMaxWid Step IngMaxWid / 20
For y = 1 To 10 ′IngMaxHeight Step IngMaxHeight / 20
thisColor = CLng(Picture1.Point(x, y))
intRed = GetRedVal(thisColor)
intGreen = GetGreenVal(thisColor)
intBlue = GetBlueVal(thisColor)
If FilterOutMainColor(intRed, intGreen, intBlue) Then
′one color met qualification
′ and increment SngRed or SngGreen etc.
sngRed = sngRed + intRed
sngGreen = sngGreen + intGreen
sngBlue = sngBlue + intBlue
End If
```
  Next
  Next
```
Me.Caption = sngRed & “,” & sngGreen & “,” & sngBlue
Me.BackColor = ReturnFinalColor(CInt(sngRed), CInt(sngGreen),
CInt(sngBlue))
End Sub
Private Sub cmdWhatColor_Click( )
Dim x As Integer, y As Integer
Const intUpperBoundX = 5
Const intUpperBoundY = 5
Dim Pixels(1 To intUpperBoundX, 1 To intUpperBoundY) As Long
Dim str1 As String
For x = 1 To intUpperBoundX
For y = 1 To intUpperBoundY
Pixels(x, y) = Picture1.Point(x, y)
str1 = CStr(Pixels(x, y)) & vbCrLf
Next
Next
MsgBox str1 ′& vbCrLf & vbBlue
End Sub
Function HowManyPixels(ByVal PictureHeightOrWidth As Single)
As Single
Dim sngCount As Single, sngCounter As Single
Dim blnAddOne As Boolean
sngCount = 0#
blnAddOne = False
For sngCounter = 0# To PictureHeightOrWidth − 1#
sngCount = sngCount + 26#
If blnAddOne Then
sngCount = sngCount + 1#
blnAddOne = False
Else
blnAddOne = True
End If
Next
HowManyPixels = sngCount
End Function
Private Function FilterOutMainColor(ByRef Red As Integer, ByRef
Green As
Integer, ByRef Blue As Integer) As Boolean
Dim blnRed As Boolean, blnGreen As Boolean, blnBlue As Boolean
If Red < 126 And Green < 126 And Blue < 126 Then Exit Function
If (Red > Green And Red > Blue) Then
blnRed = True
ElseIf (Green > Red And Green > Blue) Then
blnGreen = True
ElseIf (Blue > Red And Blue > Green) Then
blnBlue = True
Else
Exit Function
End If
Select Case True
Case blnRed
If (Green <= (Red * 0.75)) And (Blue <= (Red * 0.75)) Then
Red = 1: Green = 0: Blue = 0: FilterOutMainColor = True
End If
Case blnGreen
If (Red <= (Green * 0.75)) And (Blue <= (Green * 0.75)) Then
Red = 0: Green = 1: Blue = 0: FilterOutMainColor = True
End If
Case blnBlue
If (Red <= (Blue * 0.75)) And (Green <= (Blue * 0.75)) Then
Red = 0: Green = 0: Blue = 1: FilterOutMainColor = True
End If
Case Else
Red = 0: Green = 0: Blue = 0
End Select
End Function
Private Function ReturnFinalColor(ByVal Red As Integer, ByVal
Green As
Integer, ByVal Blue As Integer) As Long
If Red > Green And Red > Blue Then
ReturnFinalColor = vbRed
ElseIf Green > Red And Green > Blue Then
ReturnFinalColor = vbGreen
ElseIf Blue > Red And Blue > Green Then
ReturnFinalColor = vbBlue
Else ′black
ReturnFinalColor = vbBlack
End If
End Function
